(19) United States
(12) Patent Application Publication
(10) Pub. No.: US 2016/0358013 A1
(43) Pub. Date: Dec. 8, 2016

(54) METHOD AND SYSTEM FOR AMBIENT PROXIMITY SENSING TECHNIQUES BETWEEN MOBILE WIRELESS DEVICES FOR IMAGERY REDACTION AND OTHER APPLICABLE USES

(71) Applicant: Aerdos, Inc., Port Orange, FL (US)

(72) Inventors: Matthew Dale Carter, South Lebanon, OH (US); George Theodore Kyrazis, JR., Port Orange, FL (US); Scott Joseph Berger, Cincinnati, OH (US)

(73) Assignee: Aerdos, Inc., Port Orange, FL (US)

(21) Appl. No.: 15/170,252

(22) Filed: Jun. 1, 2016

Related U.S. Application Data
(60) Provisional application No. 62/169,610, filed on Jun. 2, 2015.

(51) Int. Cl. G06K 9/00; H04W 8/14; H04W 4/02

(52) U.S. Cl. CPC G06K 9/00288; H04W 4/023; H04W 8/14; G06K 9/00228

(57) ABSTRACT

A method and system enables mobile wireless devices to identify and track each other in a connectionless communication scheme. Various use cases are possible, including image privacy, where users carry mobile devices that advertises their preferences and positioning data to other mobile devices in close proximity. When imagery collection begins on a given device, information from other surrounding mobile devices in the proximity is collected and processed against a plurality of onboard data acquisition tools and analytics to determine if certain portions of the collected imagery require redaction/filtering based on predefined relationships with the other surrounding users with mobile devices in the vicinity. Redaction and/or filtering may be managed based on a plurality of predefined inputs such as an established contacts list.

### TECHNICAL FIELD

This application relates generally to the ability to provide real-time ambient location sensing between mobile devices in a localized peer-to-peer ecosystem to enable various functions such as imagery privacy control for users.

### BACKGROUND

A modern mobile device can include a number of computing resources packaged together in a small form factor which typically include a microprocessor(s), a wireless transceiver (e.g. Wi-Fi, Bluetooth, NFC), a cellular transceiver, a location-based receiver (e.g. GPS), multiple sensor modalities (e.g. accelerometer, magnetometer), and image collection abilities (e.g., camera or camera systems). These modern mobile devices can perform many complex computing processes utilizing extensive datasets and libraries exposed by the devices software, firmware, onboard sensors, and other data collection resources. Further, these devices are capable of multitasking, storing data parameters, displaying still and motion imagery, and adapting to a wide array of communications infrastructures including wireless networks and peer-to-peer topologies.

Some examples of wireless mobile devices include, but are not limited to, Smartphones, Tablets, e-Readers, Electronic Wearables (e.g. Watches, Fitness Trackers), Digital Notebooks, PDA's, Music/MP3 Players, Wireless Headphones, Digital Cameras, Key fobs, Unmanned Aerial Vehicles/Systems (drones), Virtual Reality (VR) components, and Portable Gaming Systems to name a few.

Typically in today's world imagery products (e.g. digital images or videos) are collected at will by users. These products are stored on the devices' internal Hard Disk Drive or Memory Space for viewing or sharing with other users and devices. This affords any user of a mobile device that is equipped with a camera sensor the ability to easily capture imagery of anyone, at nearly any time, regardless of one's personal privacy preference.

There are many places where people have growing concerns over their own personal privacy. Given the sheer volume of camera systems today, it is increasing common for people to be captured in photography or video recordings, either inadvertently or intentionally, and often times without their consent or knowledge. In the world of instant photography and social media outlets privacy is a growing concern. Many people do not want to be photographed or video recorded by others, let alone sharing without their consent. In fact many wish to prohibit the capture of their likeness for personal, political, economic, or social reasons. Again these are just a few examples of situations where people don't want to be included in imagery captured by someone else. There are literally thousands of scenarios where people wish they had more privacy when it comes to other users collecting digital imagery.

It would be desirable to incorporate a system and method within modern mobile devices that could provide an actionable ambient location service, and use that model to implement new workflows such as mobile device imagery privacy.

### SUMMARY

The aforementioned mobile devices, when properly equipped with data generation and communications abilities, may be used to perform precise ambient proximity awareness of other devices/users nearby. As these devices continuously generate vast amounts of data, that data can be formatted in such a way to perform ambient proximity estimations with other surrounding devices. Such a system could be used in a variety of applications to ultimately discover users and their preferences as it relates to the application capabilities. As one of the primary applications using this type of ambient proximity awareness, users could manage their own image privacy expectations through unique real-time imagery redaction workflows.

The following invention describes such a system capable of communicating structured metadata in a localized peer-to-peer manner to perform precise ambient location sensing While this technology could be implemented in a variety of ways to solve many ambient location or indoor positioning challenges, it can also be used as the catalyst to perform real-time imagery redaction as described herein. In particular, these location sensing techniques expose a powerful method that is capable of performing real-time imagery redaction between users of mobile devices.

In one aspect, a method of real-time ambient proximity sensing and imagery redaction involves the steps of: a device wirelessly receiving structured metadata regarding one or more other mobile wireless devices in a vicinity of the device; a device that is capable of performing imagery capture using a camera subsystem; the combination of the device and imaging system capturing an image of at least some part of the vicinity; and the imaging device utilizing the structured metadata to redact all or part of the image in real-time.

In another aspect, a method for limiting image capture operations of one or more nearby imaging devices that are part of a peer-to-peer topology using a mobile device involves the steps of: the mobile device receiving identity data or metadata regarding an imaging device; the mobile device verifying an image capture rights status of the imaging device; and the mobile device automatically transmitting image capture control data or metadata to the imaging device according to the image capture rights status of the imaging device.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 illustrates a peer-to-peer relationship and ambient proximity awareness between several mobile wireless devices;

FIGS. 2A and 2B illustrate an exemplary device set-up operation for operation within an image privacy ecosystem;

FIG. 3 illustrates several device-to-device redaction uses cases; and

FIG. 4A illustrates an exemplary device system/operation for capturing and broadcasting metadata;

FIG. 4B illustrates an exemplary device system/operation for receiving broadcasting metadata and processing the metadata for an image redaction use case;

FIG. 5A illustrates an exemplary metadata broadcast flow for non-privacy use cases; and

FIG. 5B illustrates an exemplary topology map build flow process.

### DETAILED DESCRIPTION

A method and system allows people to control their level of privacy as it pertains to the collection of digital imagery from the mobile devices of other people. Digital imagery can take on many forms of electronic data gathering from a simple still photo (e.g. JPEG, GIF) to full motion video (e.g. MOV, WMP, AVI, MPEG). This method and system works by creating an ecosystem of mobile wireless devices that have an awareness of other mobile wireless devices around them as they come within sufficient proximity of each other (e.g., within wireless range of each other). This type of location awareness is referred to herein as ambient location sensing, which involves locating a specific object or subject using electronic data gathering and processing techniques.

Typically, users maintain a close physical relationship with their wireless devices, keeping them either on or near their person. Some examples include carrying a device in a pocket, handbag, in or part of a vehicle, or wearing on their person. There are many ways users maintain close physical proximity to these types of mobile devices. As these devices in the ecosystem are in motion they continuously communicate information over a variety of RF and IR methods including but not limited to: WLAN, Wi-Fi, Bluetooth, Bluetooth Low Energy (BLE), Near Field Communications (NFC), ZigBee, Z-Wave, ANT+, Nike+, Weightless, EDGE, DECT, RFID's, WiFi Aware, 6LoWPAN, iBeacons/Beacons, Cellular (e.g. 3G, 4G/LTE), GPRS, DECT, IrDA, or other forms of Wireless IoT and/or IEEE communications protocols. Many users of mobile devices do not realize their devices frequently communicate in a wireless fashion when left enabled. Devices do this in order to search, discover, roam, and join known or unknown networks or other devices. A more recent trend is allowing our mobile devices (e.g. Smartphone, Wearable) to communicate with other sensors around us as part of the Internet of Things (IoT).

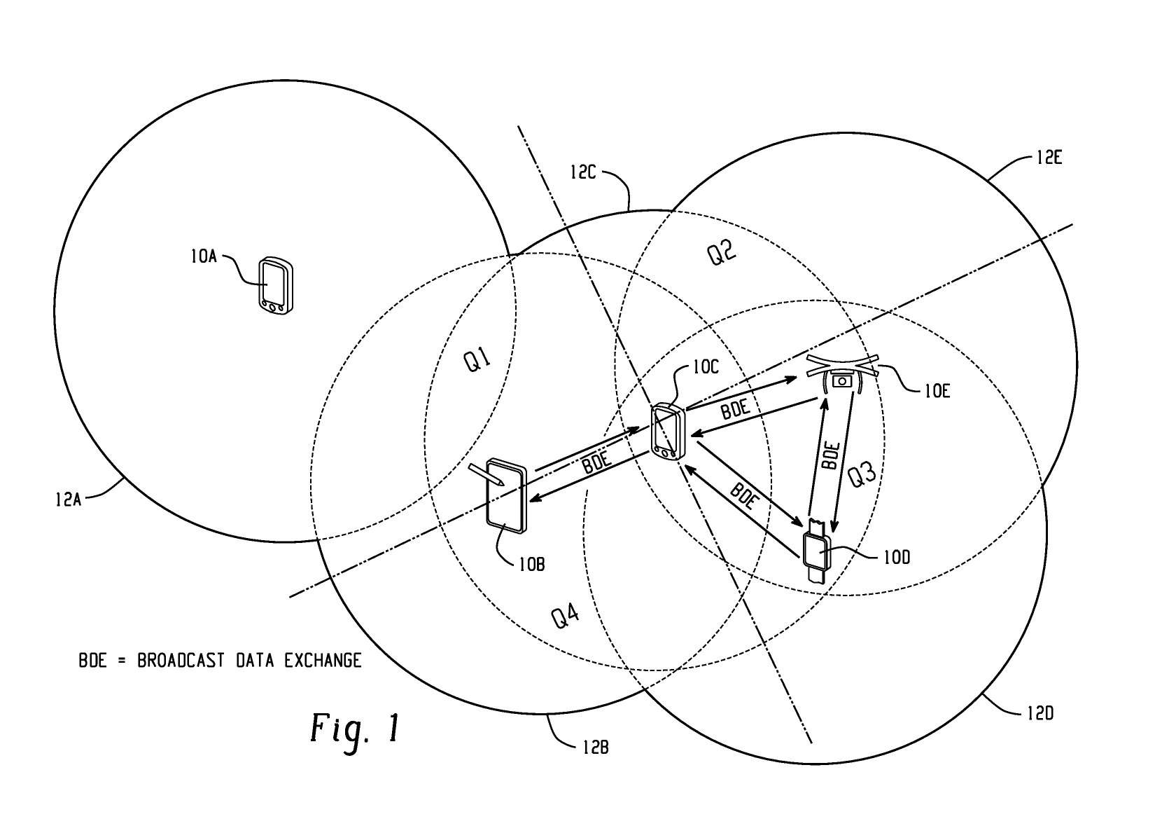

One of the methods in the present invention takes advantage of these various forms of wireless communications protocols and inserts opportunistic data, sometimes referred to as “metadata” within specific sections of a communications frame. The term metadata is used in this description as it pertains to a collection and structuring of information that may at some time be applied or referenced to a user's location, his/her device characteristics, and associated preferences. Metadata by its name is a form of structured and descriptive data about something, someone, somewhere, etc. The term data may be used interchangeably here as the information in general is data. Regardless, this data set, referred to as metadata, is comprised of information about the device, the user, contacts, and location information that may be inserted into specially formed management frames of a given communications session. As devices are constantly seeking to improve their network connection, or looking to join/host networks, they generate an abundance of communications management frames. These frames are received by surrounding devices and Wireless Access Points (WAP) as a way to communicate. The method uses opportunistic metadata that rides within these automatically generated management frames. Essentially, the method makes more efficient use of these communications sessions, by also sharing localized relationship data with other devices nearby. Since the information is propagated from the mobile devices antenna over an RF channel, it not only reaches its intended device (e.g. Wireless Access Point), but can also be received by other proximate devices such as smartphones within the ecosystem—similar to a broadcast. When a mobile device comes within range of another mobile device's broadcast footprint, the devices can communicate using a series of connectionless wireless messages. As these footprints overlap to allow communications, layered and structured metadata may be exchanged between devices. In the example depiction of FIG. 1 devices 10C (smartphone), 10D (watch or other wearable) and 10E (drone) include respective wireless broadcast ranges/footprints 12C, 12D and 12E, and can all exchange metadata with each other. Devices 10B (tablet) and 10C, each with respective wireless broadcast ranges/footprints 12B and 12C, can also exchange metadata with each other. However, device 10A, with wireless broadcast rang/footprint 12A, cannot exchange metadata with any of the other devices. By exchanging metadata when possible, each device is capable of building an awareness topology of other devices/persons nearby and where they are in relation to it. When this type of information is processed, it can be used to determine if a device nearby is known by the user or not, precisely where the device is in relationship to it, and in an application oriented sense if that device is permitted to capture imagery (e.g., based upon preferences information).

In the more exact application of imagery redaction workflows, one method to provide users a way to manage who is permitted to take imagery of them, is to use a predefined contacts list on the device comprised of people they already know. Other methods may include allowing permissions based on specific geographic locations (e.g. a known residence or venue that permits imagery). Contact lists may also be sourced from social media accounts (e.g., Facebook, LinkedIn, Twitter, Snapchat or others), which could be used to drive permissions settings. The method may allow for hybrid combinations of permissions based on predefined contacts and geographical locations as an example. Just as mobile devices or smartphones are capable of storing contacts with personal information, names, addresses, phone numbers, email, etc., the same contact list may serve as a master permissions list allowing or denying those contacts permission to take digital imagery of them when they are discovered nearby. In the model where users carry a mobile device with an established contacts list, they can create permissions for each individual contact. This establishes a set of granular user-defined rules and builds some expectation of privacy control per contact.

Of course, other applications and uses for this type of ambient proximity awareness may exist such as indoor/building navigation aids, search and rescue systems, security tracking and discovery of people or places are a few more examples. In any of these applications the mobile devices perform automatic ambient proximity awareness as they come in proximity of each other. This allows structured and layered metadata, rules, and preferences to be automatically shared in a peer-to-peer localized environment forming the basis of an automated, rules-driven application oriented model between users of mobile devices (e.g. imagery privacy, navigation aids, people finders, etc).

One specialized class of metadata/data that may be used for the purpose of imagery redaction is biometric metadata that algorithmically describes the probability of physical appearance of the face of the person desiring privacy. This metadata/data can be created during a system configuration process, when a user is setting privacy settings and otherwise configuring the system. The user takes a photo or series of imagery products of his/her face, which is used to generate a composite set of algorithmic data sets that describes him/her. While various implementations of facial recognition systems may exist, in one embodiment the system uses a version of facial recognition that applies a 128-dimensional vector description to each face. These descriptions vary greatly as the identity of the person changes, but vary slowly as unimportant information changes (e.g. backgrounds, expressions, pose, lighting, etc). This biometric data may be passed along with the other device metadata/data and used by the camera subsystem as an ultimate person based filtering method during the picture or video capture process.

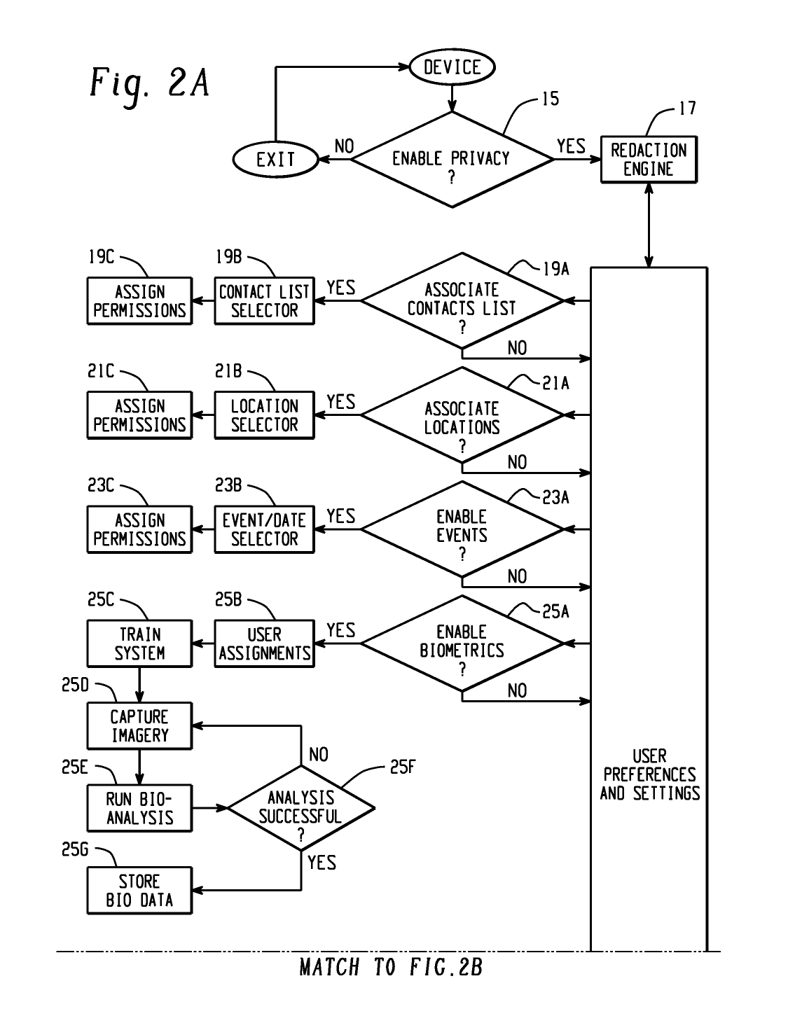

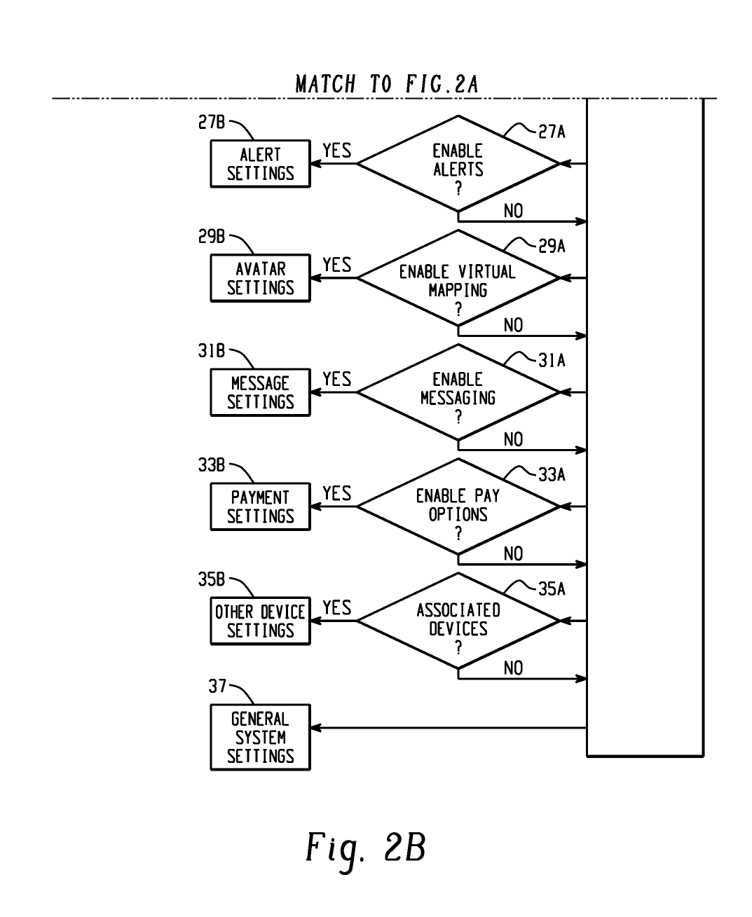

By way of example, reference is made to FIGS. 2A and 2B in which an exemplary operation flow for an image privacy application or image privacy operating system service is shown, which may be triggered through a user interface on the mobile device. A user enables image privacy at flow step 15 and the image redaction engine is activated at flow step 17. The user may also be presented with an interface that enables the user to make a variety of setting adjustments. For example, a user may indicate he/she desires to associate a contacts list or lists for set-up at flow step 19A, in which case a list of available contacts lists may be displayed for the user and user may select one at flow step 19B. The user then assigns image privacy rights and other permissions for each contact in the list at flow step 19C. The user may select to associate locations at step 21A, enabling specific locations or georeferenced areas to be input or selected at step 21B and specific permissions to be assigned to such locations at step 21C. For example, a user could select to always allow image capture at the user's home residence or to always deny image capture when the user is at a fitness facility. Event based permissions can also be defined per flow steps 23A, 23B and 23C. For example, a user may define specific image capture rights according to a calendared event such as a wedding.

A user may also select biometric set-up at flow step 25A. The user then identifies or inputs the specific user at flow step 25B (e.g., where multiple potential users of the mobile wireless device are possible, such as a phone used by both a parent and a child). Once the user is identified the system is trained per flow steps 25C-25G by capturing image(s) at flow step 25D, running bioanalysis of the image(s) at flow step 25E, and verifying for accuracy at flow step F. If accuracy is not verified, steps 25D-25F may be repeated. If accuracy is verified, at flow step 25G the biometric data may be stored (e.g., on the mobile wireless device and/or uploaded for storage to a cloud-based system for future access by other mobile wireless devices).

The alert settings flow steps 27A and 27B allow various alerting criteria to be set, such as notifying users of possible redaction conditions, notifications of contacts nearby and potentially the hierarchy of such contacts, the utilization of color squares in viewfinder (described further below), etc. The virtual mapping flow steps 29A-29B allow users to update their virtual presence on a topology awareness map, such as by the use of various avatars, color codes, symbols, etc. The messaging flow steps 31A-31B allow users to send short messages, requests, updates between devices. For example, if a user is not a known contact of another user but wants to send a request to take a picture of the user. Other types of messages, requests, and rule updates could be exchanged within the system with ease based upon message settings. The payment flow steps 33A-33B allow users to assign payment options to receive an “un-redacted” imagery product. For example, in certain venues (e.g., a concert or sporting event) all image capture could be precluded unless a user pays for image capture rights. Some examples of payment systems could include issuing electronic payments, redeeming user rewards/points and/or consuming advertisements. The devices flow steps 35A-35B allow users to associate devices together. For example, a child's wearable may be “tethered” to a parent's mobile phone. Other setting options are also possible per 37. For example, storage location, frequency of broadcast updates, location settings, local device settings, cloud settings, encryption settings, assignable communication methods and priorities, etc.

The discovery process of mobile devices within an ecosystem is just one of the components of device-to-device or peer-to-peer image redaction. Further, each device that is capable of taking digital imagery should also be able to discern where the other devices around it are and their physical relationship to them. This method involves the exchange of structured metadata that upon availability is layered information fields about a device with other surrounding devices. The method may utilize a combination of data types including specific device information, signal characteristics, contact relationship, location, preferences, and analytics. These data sources that form the structured metadata maybe derived from a number of device and/or user inputs including things like: a UUID, MAC Address, GPS data, Sensor data, RF characteristics, Personal Information, and even biometric profiling. While some data may be sourced directly from a sensor (e.g., on-board accelerometer, GPS) other personally identifiable information may be stored or contained through the use of UUID (unique user identification) systems that reference other information. While it is optimal to collect as many information types as possible, all information types are not necessarily required for the ambient location sensing to function properly. Some devices may have limitations as to what kind of information can be provided by the device and incorporated into the metadata structure. While many mobile devices (e.g., smartphones, wearables) include a wide array of embedded sensors and data acquisition tools for the purposes of advanced application processing, other devices may not be as feature-rich or diverse. The metadata model allows for embedding information from multiple data sources, but is not dependent on all of them if some are absent. Therefore, the metadata model is flexible and intelligent enough to provide ambient location sensing capability with as many, or as few, data fields that become available by a device—in essence layering data for improved sensing. In some instances where the metadata cannot distinguish a specific user, on-board biometric analytics maybe utilized to detect and/or identify a user more accurately. Regardless of the number of data sets that are incorporated into the metadata model, the more data that can be exchanged and shared between devices, the greater the probability/success of location sensing and targeted user determination.

The ambient proximity functionality is designed in such a way that it can make intelligent estimations to drive decisions using, for example, the least expensive cost and lowest latency method combined. This means that the algorithm may be designed to filter metadata information using a combination of least difficult and latent to accurately identify its probability of awareness relationships with other devices nearby. This method solves several technical problems, from conserving battery life of a device to making actionable decisions quickly with confidence. Table 1 below shows an example metadata construct of information/data that may be exchanged between devices. Variations are possible, as all, some, or additional fields of metadata based on the various device types in the market, user information, and metadata generation ability of those devices and/or users may be implemented in any given circumstance. While some information may be generated and exchanged locally between devices (e.g., device accelerometer, device GPS) it may be desirable to store other information in a secure database and referenced those data sets through UUID services. Other hybrid approaches may be utilized allowing device-to-device location sensing to function either with or without Wide Area Network connectivity to external compute and storage systems.

TABLE 1
METADATA MODEL

| Field Number | Field Description | Max Byte Length |
|---|---|---|
| 1 | Checksum | 2 |
| 2 | TimeStamp | 8 |
| 3 | LocalPrefData | 64 |
| 4 | UUID | 8 |
| 5 | MacAddr | 6 |
| 6 | IpAddr | 16 |
| 7 | Latitude | 4 |
| 8 | Longitude | 4 |
| 9 | Altitude | 4 |
| 10 | HorizontalAccuracy | 4 |
| 11 | VerticalAccuracy | 4 |
| 12 | Azimuth | 4 |
| 13 | MagNorth | 4 |
| 14 | TrueNorth | 4 |
| 15 | Bearing | 4 |
| 16 | Course | 4 |
| 17 | Heading | 4 |
| 18 | Distance | 4 |
| 19 | SignalType | 2 |
| 20 | SignalStrength | 4 |
| 21 | AccelerationX | 4 |
| 22 | AccelerationY | 4 |
| 23 | AccelerationZ | 4 |
| 24 | RotationX | 4 |
| 25 | RotationY | 4 |
| 26 | RotationZ | 4 |
| 27 | Pitch | 4 |
| 28 | Roll | 4 |
| 29 | Yaw | 4 |
| 30 | ActivityStatus | 2 |
| 31 | Analytics | 1024 |
| 32 | Aux01 | 4 |
| 33 | Aux02 | 4 |
| 34 | Aux03 | 8 |
| 35 | Aux04 | 8 |
| 36 | Aux05 | 16 |
| 37 | Aux06 | 16 |
| 38 | Aux07 | 32 |
| 39 | Aux08 | 64 |
| 40 | Aux09 | 128 |

One of the modalities for determining position is derived from the Global Positioning System or GPS. The United States Government controls and operates the Global Positioning System, made up of an operational 24-satellite constellation, which carry extremely accurate and synchronized atomic clocks. Many mobile devices include a GPS-enabled receiver to provide time and position information to the device when an on-board application or Operating System requests it. Positioning or timing data may also come from other services (e.g. cellphone towers, Wireless Positioning Systems, etc.). However, given the precise timing relationship of the GPS, GPS can be used to determine location or positioning of a mobile device with a good level of accuracy in many circumstances. A typical mobile device (e.g., smartphone) includes a GPS-enabled receiver that is capable of receiving GPS data from more than one satellite at a time. Signals from each satellite travel at the speed of light and are intercepted by the device's embedded GPS receiver. Each of the received GPS signals provides information about its time and position at regular intervals. As these signals are intercepted, the devices GPS receiver calculates how far away each satellite is based on how long it takes for the messages to arrive. Generally, it is possible to receive data from several GPS satellites at any given time provided there are no obstructions to them such as tall trees or buildings. The more GPS satellites that are being tracked on the device the greater the location accuracy will be. If a GPS receiver is able to track at least three satellites concurrently, a process called trilateration is performed to determine the device's coordinates (latitude and longitude). If the mobile device is able to lock to a fourth satellite signal, the receiver can also determine altitude providing a more exact location of the device.

While GPS information is used within the metadata model it is not always sufficient enough to perform a precise grade of ambient location sensing. According to information from the U.S. Government about the Global Positioning System, actual user accuracies depend on a variety of factors including atmospheric effects, sky blockage, and device receiver quality. Some real-world data shows that high-quality GPS receivers that are unobstructed can only provide approximately 3.5 meter horizontal accuracy. In cases when GPS information is not accurate enough to discern a precise location/target, or GPS data is not accessible (e.g. indoors, underground) a GPS augmentation system can be used to increase the location accuracy. The current ambient proximity detection system utilizes many layers of information in the metadata exchange as a method to augment GPS systems when the GPS error rate is too high to produce accurate results.

While trilateration is the basis of how GPS works and is the process of determining a location by measuring distances, it is not to be confused with triangulation, which is a process to determine a location based on measuring angles. In cell tower triangulation, the cell tower's antenna arrays are arranged in a triangle, each array covers a 120 degree sector from the tower. As a mobile device enters into a given sector, the cell tower understands which sector the device is in and can estimate the devices distance from the tower by measuring its RF signal strength. When a device enters into a space that can be covered by two cell towers, the location accuracy is greatly improved by knowing the corresponding sectors and measuring relative signal strength between the device and towers, this also creates overlapping coverage from where the cellular signals are being received by the device. Adding a third or more towers further increases the location accuracy following this process. Similarly, Wi-Fi triangulation may be used as a method for ambient location fixing by knowing the exact positions of Wireless Access Points (WAP) and measuring the intensity of the received signal strength from a mobile device to each WAP. Accuracy in this model is also dependent upon the number of WAP's utilized in a given space (e.g. retailers, hotels, airports, theme parks, etc). The current invention utilizes a metadata construct that is capable of sourcing location data from any of these location based services or using these architectures as a grid system to understand positioning. Furthermore, as other methods of location services become more mainstream and available (e.g. web services, magnetic headings, RF Navigation Aids, etc), those methods may also be incorporated as viable location based services.

Aside from mobile device discovery and determining location of devices, each mobile device will also need to communicate information with other mobile devices nearby. As data is assembled and carried in a structured metadata format, the information is regularly updated by the device and communicated to other devices nearby (e.g., in a connectionless communication scheme format). There are essentially three modes in which wireless devices in the ecosystem will operate. The first mode is “Transmit Only.” In this mode a device will need to periodically broadcast details about who and where it is. A second mode is “Receive Only.” In this mode a device is actively listening for messages and making some decisions when intercepting them. The third mode is “Multi-directional.” In this mode a device is not only broadcasting information about it, but it is also receiving information from other devices nearby, and making decisions based on those received messages. Some devices may be capable of supporting all three modes, whereas others may only be capable of supporting one or two modes. In the case of a device that has a camera (e.g. smartphone) to capture digital imagery, these devices must support “Receive Mode” and/or “Multi-directional Mode” in order to assure that when a device is capturing imagery, in the imagery redaction workflow, the device is capable of receiving data from devices nearby that have opted into the image privacy ecosystem and have assigned imagery permissions to specific contacts or locations. Simpler mobile devices, such as wearables (e.g. Fitness Trackers, Watches, Headphones) or devices that do not have imagery capturing ability, may only need to support “Transmit Mode” to make sure other devices nearby are aware of their presence by distributing imagery collection metadata when opted into the ecosystem. Those devices with imagery collection capabilities should be required to participate in a “Receive Only” mode at a minimum to process and comply with privacy requests from devices nearby. Whereas wireless mobile devices that do not have imagery collection capabilities may be provided an option of advertising information into the ecosystem, depending on whether imagery privacy is or is not a concern to the user (e.g., a user may control an ON/OFF status of the data sharing function via an interface of the device).

When a user's structured metadata set is ready to be exchanged from device-to-device, it will be advertised in a broadcast fashion as discussed previously. Prior to actual transmission from device-to-device the metadata model may be also encrypted to provide an added layer of protection, and to prohibit the exploitation of a user's location or imagery redaction metadata for improper use or manipulation. In devices that support communications over IEEE 802.XX standards, the metadata may be opportunistically inserted into the unused space of wireless communications management frames. Management frames are used in wireless networks to manage communications sessions within a network. Historically these management frames were not designed to carry user payload, however in the current method and system these specialized frames may be “oversubscribed” to carry opportunistic metadata about the user and their device. This opportunistic metadata is a form of management information for devices, and not necessarily defined as user generated data (e.g., web browsing, online gaming). Oversubscribing the management frames is a process also referred to as bit-stuffing or beacon-stuffing, depending on which management frame is being oversubscribed. In the case of beacon frames, these are just one type of management frame in an IEEE 802.11 network or Wi-Fi. Beacon frames are transmitted periodically to announce the presence of a Wireless Local Area Network (WLAN). Typically beacons are transmitted by Access Points (AP) or hotspots to notify wireless devices of their availability.

Mobile devices can also provide capabilities such as mobile hotspots that act as an Access Point, allowing them to generate beacon frames to advertise network availability to other devices around them. In the current system and method a mobile device's camera or camera application could be tied to the device's wireless radio, even more specifically, the hotspot generation capability, thus broadcasting the beacon management frames as a carrier of opportunistic metadata to other devices nearby. Similarly other wireless devices may be scanning for suitable Access Points to allow it to improve networks, roam, join, etc. Typically mobile wireless devices have two modes of scanning ability: Active and Passive. During an Active Scan, a wireless device sends a management frame called a “Probe Request” to solicit a “Probe Response”; whereas in a Passive Scan the radio listens on each channel for a brief period for “Beacons” from an available Access Point(s). This implementation of the communications model depends on the ability to oversubscribe or bit-stuff metadata into the wireless management frames to exchange structured metadata between devices either for location sensing in general or in regards to imagery privacy or some other use case.

Another method to exchange metadata between mobile wireless devices in a connectionless peer-to-peer ecosystem can utilize Ethernet broadcast frames and/or Ethernet multicast frames, as these too are viable methods for carrying information from one device to many. Ethernet Broadcast Frames provide a mechanism to distribute data from one device to many. However, in a broadcast data must be delivered to all devices in a network. Multicast is similar to Broadcast in that it can send data from one device to many. However, in a Multicast frame data is sent to a group and only members of that group can receive it. Devices that are interested in a Multicast must join the Multicast group to receive the data. These methods may not need to employ bit-stuffing or oversubscribed management frames. Instead, this particular method may simply insert the metadata/data directly into these types of special Ethernet frames as a means to exchange information between devices regarding location sensing and/or imagery privacy.

As metadata is exchanged between mobile devices various data parameters are passed to between platforms to calculate proximity awareness. As mentioned earlier, these data parameters may be inclusive of all or some metadata fields defined in Table 1. The more metadata fields that are made available between devices could make proximity location detection easier and faster, allowing the platforms to choose which fields carry more decision weight than others, and ultimately making application decisions easier and/or faster. Referring to Table 1, generally Field 3 may carry multiple types of data, including a user's privacy setting. Fields 4-6 can be referred to as carrying device identification metadata, where the UUID may be assigned by the privacy ecosystem when a person signs up by downloading an App, or at the time of device manufacture in the case of a mobile device manufactured with the privacy ecosystem functionality built-in, the MacAddr is typically burned into the mobile device and the IPAddr is dynamically assigned by a network host. Fields 7-11 can be referred to as carrying device location metadata (e.g., as determine by an on-board GPS, from WiFi or cellular determination or from a combination of the same). Fields 12-17 can be referred to as carrying device direction metadata, where the metadata assigned to the fields can be determined in part from an on-board magnetometer (e.g., a digital compass). Fields 18-20 would typically be fields in which no broadcast data is included, but the receiving mobile device may assign metadata to these fields based upon on-board processing. Fields 21-29 may be referred to device orientation fields, where the acceleration fields 21-23 may be sourced from an on-board accelerometer, the rotation fields 24-26 may be sourced from an on-board gyro and fields 27-29 may be derived from the rotation fields or sourced from an on-board gimbal. Field 30 may carry metadata indicative of the mobile device status (e.g., idle, been in motion, actually in motion and for how long). Field 31 may carry biometrics metadata (e.g., the biometric vector data mentioned above). Fields 32-40 represent auxiliary fields for providing such additional metadata as may be useful for any given use application. Ideally the metadata structure is under 1500 bytes in size making it comparable to the payload of a single IP packet in Ethernet networks. The frequency or repetition of these metadata packets being sent may vary based on availability of device metadata and the bandwidth of the wireless communications method being used (e.g., WiFi vs BLE).

The following examples for an imagery redaction workflow demonstrate the value of using a layered metadata approach in making targeting location sensing decisions. In the first example using the five mobile devices 10A, 10B, 10C, 10D, and 10E that are located as shown in FIG. 1, each device is responsible for building a topology awareness map of the other surrounding devices by receiving metadata from the surrounding devices as they come within sufficient proximity such that wireless metadata package broadcasts can be received. If each of these specific devices are set to request imagery privacy (e.g., the devices privacy request status is set accordingly in the preference field the devices are unknown to each other or are blocked contacts), the devices may only need to know the “Preference Data” metadata and/or UUID metadata from which preference values can be determined to make the appropriate redaction decisions for each device. In this first example if all of the devices are set to “enforce imagery privacy”, none of the location values and other data sets are critical in making an easy redaction decision—redact all. However, if suddenly devices 10B and 10C are permitted to capture imagery of each other, but devices 10D and 10E are not, more information would be required for the devices to determine where they are in their own topology maps. From the perspective of device 10C, we see that device 10E is approximately 180 degrees to the rear, and similarly device 10D is approximately 235 degrees to the rear. Further, where device 10C assigns zones, such as quadrants Q1, Q2, Q3 and Q4 to its topology map, the devices 10D and 10E can be assigned to quadrant 3 of device 10C's topology map. Therefore, the location decisions for device 10C could be based on course quadrant information by calculating the location, distance, and orientation vectors for devices 10B, 10D, and 10E. In the current example, location, distance, and orientation vectors may be generated based on GPS data from all devices and a unique UUID to identify each device correctly. Therefore at that moment any device positioned in device 10C's quadrant 3 sector, at any distance, should not be permitted to take or exchange imagery.

Modifying this to a new second example, if all of the devices 10C-10E where suddenly inside of a building, using the same locations and user preference values, the GPS error rates may exceed a trusted threshold thus requiring more information from the exchanged metadata model to make better redaction decisions (e.g., another layer of metadata analysis). In this event processing of the magnetic heading or bearing fields may be used to supplement the location calculations by building a reverse azimuth for devices still located in device 10C's quadrant 3 zone.

Consider a third example, using the same five devices illustrated in FIG. 1, with the same contact preference values (only device 10B and 10C permitted to exchange imagery), with the location being at an outdoor public park where all devices are in relatively close vicinity of each other, with some typical obstructions such as trees and buildings nearby. It may not always be possible to rely just on vectors derived from GPS and/or magnetic fields, especially if tall trees or buildings are obstructing the sky and/or creating magnetic disturbances causing the error rates to be too high for certainty. It may be possible that analysis of additional information (e.g., a further layer or layers of metadata analysis) to obtain distance, activity, or altitude could be acquired using additional fields in the metadata model. Continuing from the perspective of device 10C, if devices 10D and 10E are still unknown or blocked contacts, and they happen to be at a considerable distance away from device C, it is possible device 10C could use information about RF signal levels from each device to determine an approximate distance location for devices 10B, 10D, and 10E. For instance if device 10B is nearby, its RF signal strength would be greater than devices 10D and 10E, signifying it is closer to device 10B. If device 10D is idle, (e.g. no variation in accelerometer data) the activity data and low RF signal strength may further help location sensing probability. The combinations of RF signal strength and activity status combined with the UUID may identify that particular device in relation to other devices around it. Assume by way of example the characteristics of device 10D suggest it is a user on a park bench reading a book with a smartwatch or fitness tracker attached to their person. The layered data collected during the metadata exchange could be enough for device 10C to determine with certainty where the user of device 10D is located within the park. Similarly, by looking at FIG. 1 we know device 10E is an aerial hobby drone. While it may be more likely we can trust the GPS data coming from the drone to determine location, additional metadata discriminators for its UUID maybe its elevation or altitude fields being more unique than other devices around it. There are numerous forms of layering data that may be used to help determine location and preference information by any of the devices in the ecosystem.

If the proximity or topology build algorithm on device 10C was still having difficulty with any of the other devices, and the margin of error was still too high to discern location, the redaction engine on device 10C could ultimately call biometric analytics to help reach a decision about the device and/or user in question. In other words when all of the location estimation tools have reached a high enough margin of error, causing too much uncertainty for the location sensing algorithm to make a certain decision, the redaction engine may need to exercise an analytic such as facial recognition to assist in solving the problem. Doing this would require the device 10C to exhaust a number of metadata layering permutations within a reasonable time frame, and then process layer rich analytic data to overcome uncertainty. Various forms of analytics may be made available to the system. It is also recognized that, from efficiency standpoint, it would be desirable to avoid using this ultimate level of device/user confirmation when possible.

In the specific use case of imagery redaction or other workflows based on people finding, when a device discovers other proximate devices, and has exchanged metadata using one or all of the above methods, a device's camera system can use the relative location information, facial detection, and facial recognition subsystems to determine the presence of faces or people in the camera frame. When the camera system is turned on, an active process determines the probability that a nearby user desiring privacy is in the camera's field of view. Initial filtering methods are performed by comparing the probable locations of those users with respect to the camera's orientation. As the probability that a user is entering the field of view increases, additional filtering methods are used to further discriminate the user's presence in the camera's frame. Onboard facial detection systems actively determine the presence of people's faces in the frame. If needed, the biometric profile described previously is then used to determine if detected faces match those of users desiring privacy or discovery. In the case of imagery redaction when those are detected in the camera frame, their faces and/or bodies will be redacted by applying any number of image processing filters to them. These filters include but are not limited to blurring or averaging filters, such as Gaussian blur, motion blur, mosaic filters, setting all pixels to a single value or any other nonreversible image processing filters. If the calculated error in the location-based filtering method, the number of faces detected in the frame, or the number of nearby users desiring privacy is low, the filtering process may be terminated when a high probability of success is calculated. In complex scenes with large numbers of faces in close proximity to each other, or when the calculated location error is high, biometric (facial recognition) methods may be necessary. The system/method will automatically employ any or all of the described filtering and identification techniques in any instance to maximize the probability of detecting all required facial targets while minimizing the strain on computing, power, communications, latency, and storage infrastructure in the device.

As described above, the diagram of FIG. 1 illustrates a peer-to-peer relationship between several mobile wireless devices 10A-10E. Each device is capable of emitting and receiving a wireless communications footprint 12A-12E. When these wireless footprints overlap other devices, the devices are able to exchange data/metadata. Communications between devices within each other's footprints is performed through a series of one-way broadcasts or connectionless communications sessions. When metadata packages are exchanged between devices, each device learns which surrounding devices and users are present for the purpose of capturing imagery. If a particular device is outside of the overlapping footprint (e.g., device 10A in the illustrated example), that device and other devices may remain undiscovered until they reach a close enough proximity to other devices for metadata/data to be exchanged, and a device topology awareness map is created. The topology awareness map may, by way of example, be a table or other data in on-board device memory identifying other mobile devices (e.g., 10B, 10D and 10E) known to be in proximity to the device building the map (e.g., device 10C), along with the approximated location of each such device and, in some cases a zone assigned to such devices. In some implementations, the device may provide a mode in which the known surrounding devices are shown on a display screen of the device to provide relative location feedback to the device user. The display could be interactive, such as allowing the user to select a given device to find out more about the device (e.g., what type of device it is, whether the user is a known contact etc.).

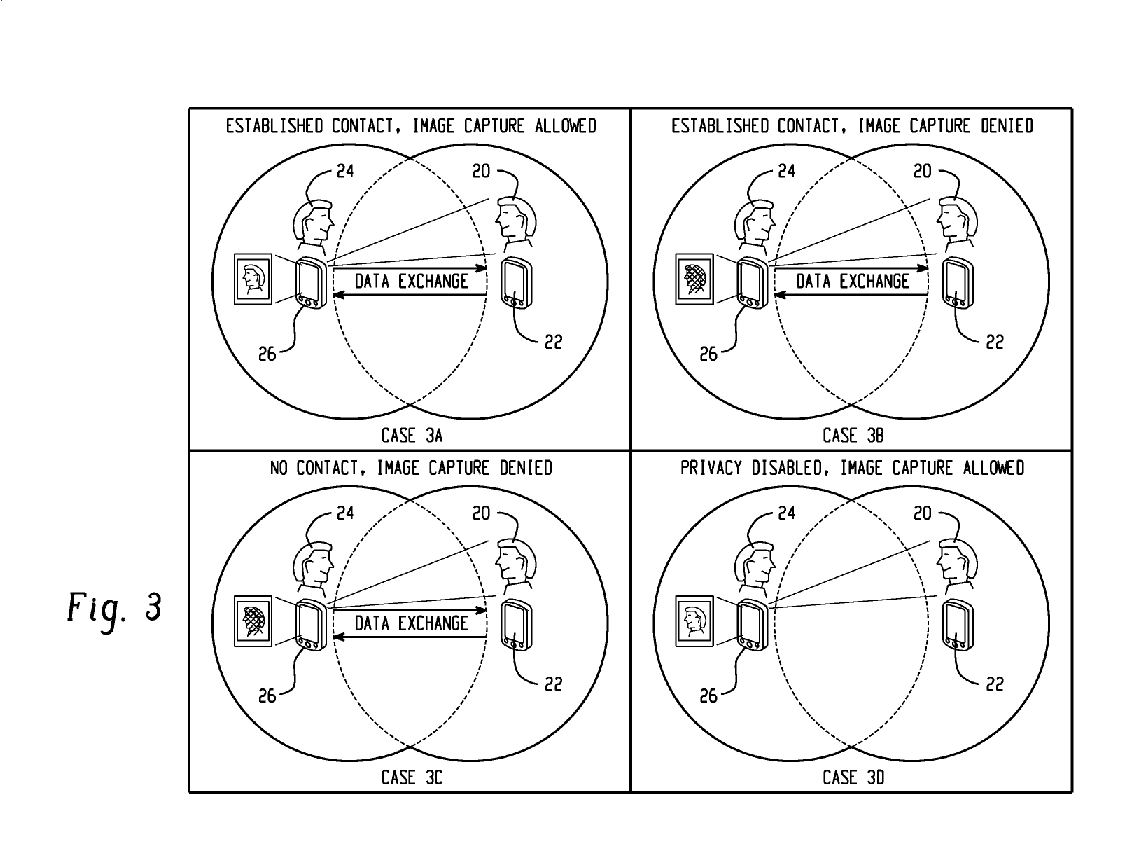

The diagrams of FIG. 3 illustrate several device-to-device redaction use case workflows. The first use case 3A shows an example of imagery that is authorized by the subject to be captured. That user 20 of device 22 has created a contact with the user 24 of device 26 and granted permissions to that contact 24 to take imagery of him/her. This results in a normal, unmodified picture being taken as shown. In one example of this use case 3A, device 26 receives metadata from device 22, uses that metadata to identify user 20, verifies the existence of user 20 as a contact of user 24, and verifies that user 20 has granted user 24 image capture rights, enabling device 26 to capture the image of user 20 without redaction. The second use case 3B shows an example of imagery that has not been authorized by the subject. This user 20 has created a contact with user 24 but denied permissions to that contact to take imagery of them, resulting in imagery redaction. In one example of this use case 3B, device 26 receives metadata from device 22, uses that metadata to identify user 20, verifies the existence of user 20 as a contact of user 24, and verifies that user 20 has not granted user 24 image capture rights, causing device 26 to redact the image of user 20 upon capture. The third use case 3C describes a user 26 who attempts to capture imagery of an unknown person 20 or someone who has not developed a contact relationship with them. Since the unknown person 20 has not granted permissions to this user 26 trying to take imagery, the imagery will be redacted upon capture. In one example of this use case 3C, device 26 receives metadata from device 22, uses that metadata to identify user 20, verifies that user 20 is not a contact of user 24, and verifies from the metadata that the user is requesting image privacy, causing device 26 to redact the image of user 20 upon capture. The fourth use case 3D depicts a subject 20 who is not concerned with image privacy and has either disabled their imagery services, or has a device that is not within the privacy ecosystem. In this last use case a normal, unmodified picture is permitted. In one example of this use case 3D, device 26 receives metadata from device 22, uses that metadata to identify user 20, verifies that user 20 is not a contact of user 24, and verifies from the metadata that the user is not requesting image privacy, enabling device 26 to capture the image of user 20 without redaction. In another example of this use case 3D, device 26 does not receive any metadata from device 22 because device 22 is not part of the image privacy ecosystem. Device 26 identifies the existence of user 20 in the image view, but recognizes that user 20 is not associated with any known mobile device, which acts as a verification that privacy for the user 20 is not required, enabling device 26 to capture the image of user 20 without redaction.

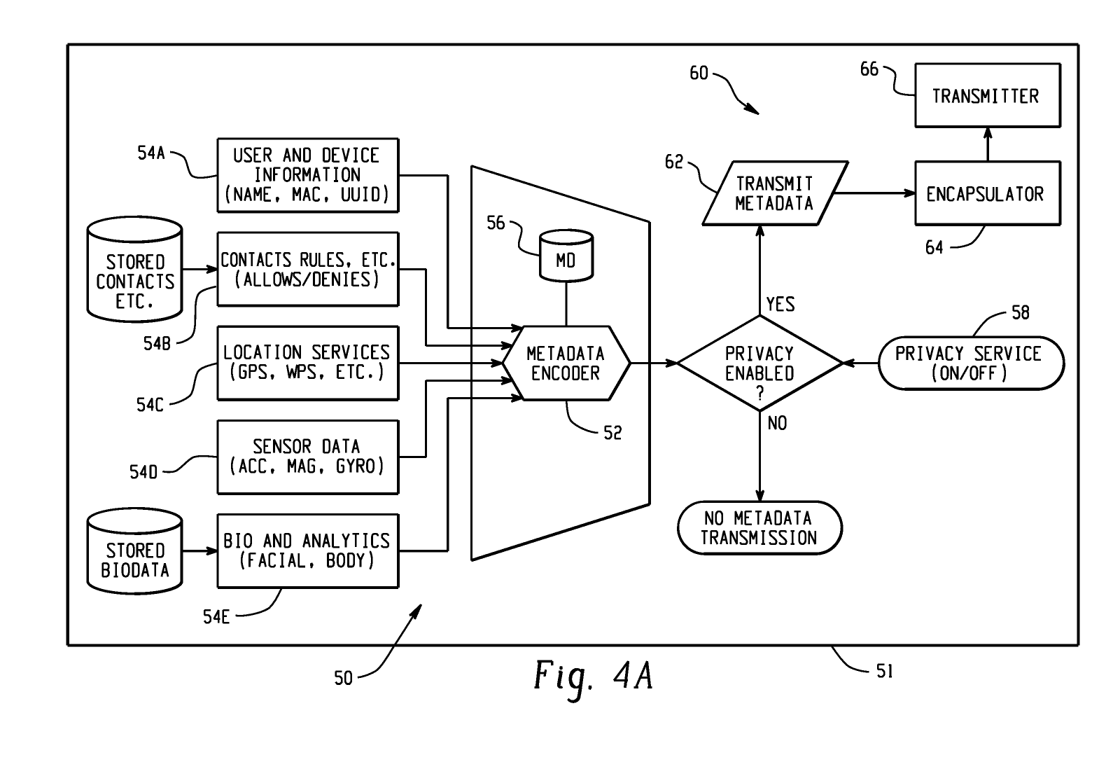

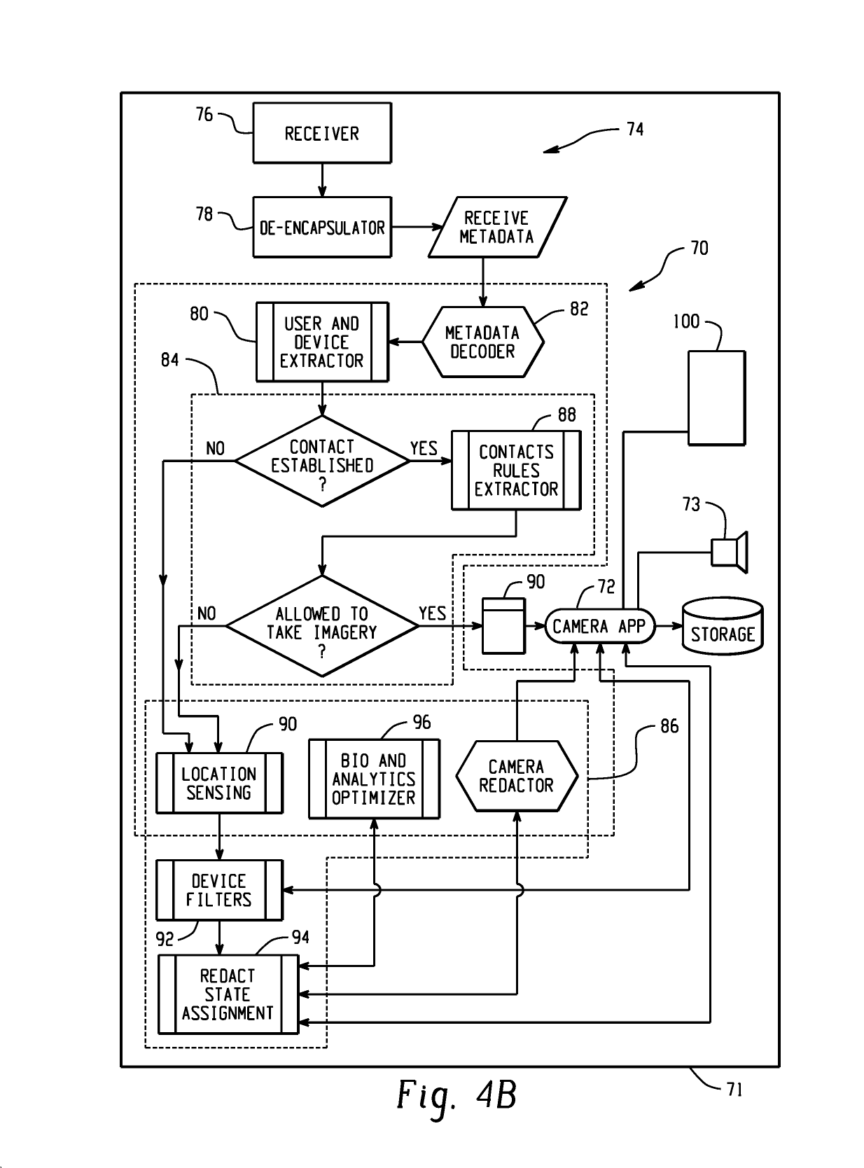

The diagrams of FIGS. 4A and 4B illustrates exemplary basic systems and signal flows and decisions list for metadata/data and redaction services on a device. The diagram of FIG. 4A shows an example of how a mobile device collects and transmits metadata/data to make other surrounding devices aware of its presence and permissions within the ecosystem. In particular, a wireless mobile device 51 includes a metadata collection and transmit system 50 that operates to configure data regarding the wireless mobile device so as to enable communication of the information to other wireless mobile processing devices. The metadata collect and transmit system 50 is configured to operate in accordance with a predefined metadata structure (e.g., the metadata model described above) with a plurality of predefined metadata fields that include one or more device identification fields (e.g., one or more of a UUID field, a MAC address field and an IP address field), one or more device location fields (e.g., one or more of a location latitude field, a location longitude field, a location altitude field and a location accuracy field or fields), one or more device direction fields (e.g., one or more of a course field, a bearing field and a heading field) and one or more device orientation fields (e.g., one or more of a pitch field, a roll field and a yaw field). The predefined metadata structure may also include at least one field with biometric facial data (e.g., biometric vector data) associated with a known user of the mobile processing device to enable other mobile processing devices with image capture functions that receive the predefined metadata model to identify the user within a captured image. As shown, the metadata collection and transmit system 50 is configured to identify data consistent with the predefined metadata structure. In particular, a metadata encoder 52 is connected to received data from a plurality of sources 54 on board the mobile processing device, including at least one device identification source 54A, at least one device location source 54C, at least one device direction source 54D and at least one device orientation source 54D. The encoder 52 is also connected through source channels 54B and 54E to access contacts and other data (e.g., including contacts rules as well as location based exceptions or event based exceptions) and biometrics data (e.g., the biometric vector data mentioned above). The metadata encoder 52 organizes and stored the identified data into appropriate fields of the predefined metadata structure (e.g., in memory 56) and will repeat the identify and store steps in order to maintain the predefined metadata structure in an updated state (e.g., making changes as necessary as the device moves to different locations and/or the orientation of the device changes).

An on-board wireless communication system 60 enables the mobile communications device to transmit wireless signals, which can include metadata when the on-board privacy service (e.g., running as an application or incorporated into the device OS) is active. In this regard, privacy service can be enabled (turned ON) or disabled (turned OFF) via a user input 58, and thus has an enabled mode in which the metadata collection and transmit system 50 operates with the wireless communication system 60 to repeatedly transmit the predefined metadata structure in a connectionless communication scheme format (e.g., a format as described above) for reception by other mobile processing devices within range. Thus, if the privacy service is enabled, the transmit metadata function 62 is repeatedly called, resulting in the metadata being packaged by encapsulator 64 and broadcast by transmitter 66. If the privacy service is disable, metadata broadcast transmissions do not take place. However, in some embodiments, in the non-enabled mode the metadata collection and transmit system 50 may continue to operate to maintain the predefined metadata structure in an updated state in memory 56 so as to enable efficient transition from the non-enabled mode to the enabled mode (e.g., all metadata up to date and ready to be broadcast when the privacy service is enabled).

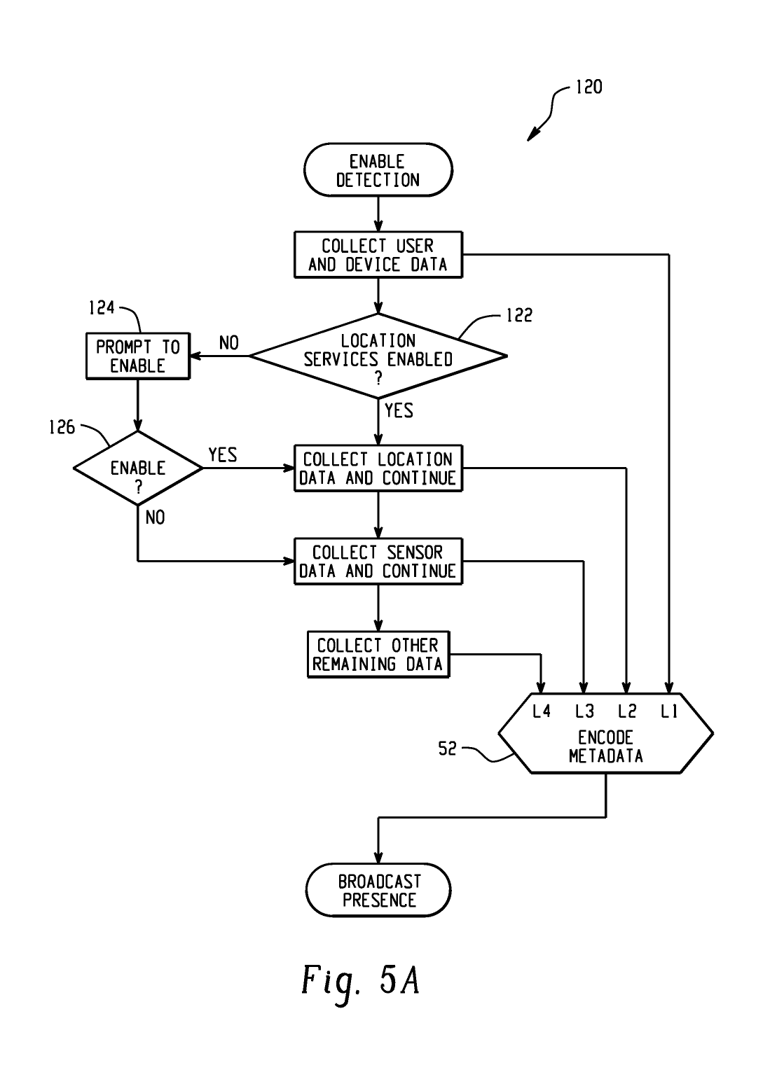

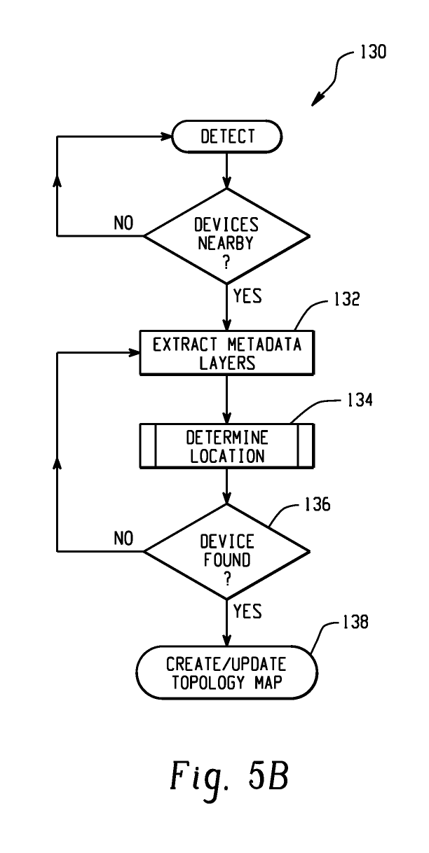

For alternative use cases not involving image privacy, the metadata transmit system could be similar to of FIG. 4A, except that metadata transmission could be triggered by an alternative user service, such as an enable detection service, in place of the enable privacy service 58. As suggested in the process flow chart 120 of FIG. 5A, biometric data may be absent from the metadata in such alternative use case. Moreover, as reflected by flow steps 122, 124 and 126, if a user does not enable the device's core location services (e.g., GPS) on his/her device ambient proximity services (detecting how close other devices are) may still be calculated by using various combinations of available metadata from other devices and performing various mathematical computations about those data fields. In such cases a broadcasting device may still be detectable, as being in a vicinity of a detecting device using device direction and device orientation fields as an example. Furthermore by nature of implementing a Broadcast Data Exchange (BDE) in an RF broadcast model, detection services could be carried to the extent of the devices RF signal propagation or signal reach.

As mentioned above, a given device may not actually have applicable data for all of the predefined fields of the metadata structure being used by the ecosystem. In such case, as one example, the metadata collection and transmit system 50 may be configured to insert null data into each field of the predefined metadata structure as to which the metadata collection and transmit system 50 lacks applicable data such that other mobile processing devices can recognize such fields as lacking applicable data when the predefined metadata structure is received. As another example, the metadata collection and transmit system 50 may be configured to truncate each field of the predefined metadata structure as to which the metadata collection and transmit system lacks applicable data such that a size of the predefined metadata structure as transmitted in the connectionless communication scheme format is thereby reduced for efficiency purposes at both ends (both the transmitting device and the receiving device that must analyze the metadata). The truncation may be achieved by using a predefined skip field delimiter in the metadata package.

The diagram of FIG. 4B shows one example of how a mobile device captures metadata from other surrounding devices and makes redaction decisions based on the information contained within the metadata. These redaction decisions ultimately provide instructions to the onboard camera sensor to collectively process imagery and perform redaction requests from other users with mobile devices. In particular, a receiving mobile wireless device 71 includes a system 70 for performing real-time onboard imagery redaction. The system includes an image capture device (e.g., a CCD camera sensor 73 controlled by a camera application 72) for capturing an image in a vicinity of the mobile wireless device. A metadata reception and decode system 74 includes a wireless receiver 76, a de-encapsulator 78 to receive the metadata packages, which in turn are fed to a metadata decode engine 80 for decoding of the metadata packages. A user identification extraction engine 82 is provided for identifying users associated with received metadata packages (e.g., based upon the UUID or other identification data in the package). An imaging rights assessment engine 84 determines whether the mobile wireless device is permitted to capture facial images of the identified users. In the illustrated embodiment, if the identified user of the device sending the metadata package is not a contact, then that identified user is deemed a user that must be redacted from captured images by the image redaction engine 86. Likewise, if the identified user associated with the received metadata is a known contact, but imagery rights have not been granted (as indicated by a contact rules extractor 88 that accesses an on-board contacts list or a cloud-based contacts list), then that identified user is deemed a user that must be redacted from captured images by the image redaction engine 86. On the other hand, if the identified user associated with the received metadata is a known contact and imagery rights have been granted (as indicated by the contact rules extractor 88), then that identified user is deemed a user that need not be redacted from captured images. The image redaction engine 86 identifies within captured images each user face that the mobile wireless device is not permitted to capture and operates with the camera application to effect redact each such user face from the captured image (e.g., using one or more of filtering, blurring, pixelizing or setting pixel values or some other form of redaction).

As shown, in the exemplary embodiment the image redaction engine 56 includes a device location subsystem 90 for processing location related metadata within the metadata packages to approximate a location of the third-party mobile wireless devices within a vicinity of the mobile wireless device, a device filter subsystem 92 for determining which third-party mobile wireless devices are likely within an image view of the image capture device and which third-party mobile wireless devices are likely not within the image view of the image capture device and a redaction state assignment subsystem 94 for identifying user faces within the image view, associating at least some of the user faces to respective third-party mobile wireless devices and establishing a redaction state for each identified user face.

The device location subsystem 90 may also be referred to as a topology build system for building the topology awareness map mentioned above, and for each mobile processing device identified by broadcast metadata packages the topology build system operates to evaluate metadata in a layered manner to assign an approximate location of the mobile processing device within the topology map and a level of accuracy of the approximate location until the accuracy level achieves some desired or present accuracy level. This process can be seen with reference to FIG. 5B, where a process flow chart 130, where steps 132, 134 and 136 reflect a repeating layered analysis of received metadata until a device is suitably located (e.g., in accordance with a desired accuracy level as determined at 136) and can be incorporated into the topology map per step 138. This layered location detection and topology build is applicable to many potential use cases beyond image privacy.

As mentioned above, the topology build system of device 71 may be configured to define a plurality of zones relative to the actual location of the mobile device 71 and to assign the approximate location of the surrounding mobile processing devices to an applicable one of the zones. This zone assignment may also occur for surrounding devices as to which redaction is not needed as reflected by the duplicate position of the device location subsystem 90 in FIG. 4B. The zone assignments enable the device filter subsystem to operate make an assessment of which surrounding devices are actually in the image view of the on-board camera based upon the known direction in which the image view is being taken by the on-board camera. This assessment enables the redaction state assignment subsystem 94 to operate by, effectively, ignoring surrounding devices that are not within the image view as the subsystem operates to assign redaction states to each face within the image view of the device 71. In some cases the redaction state assignment subsystem may need to enlist the assistance of a biometric analysis engine in order to make a redaction assignment for any given face within the image view (e.g., where two faces are too close together to make a user distinction based upon other metadata).

In some embodiments, the device 71 may include a display screen 100 for displaying the image view, and a display control (e.g. the camera app itself) that is configured to cause each user face within the image view to be displayed with an associated graphic that indicates whether the user face will be redacted based upon the redaction state established by the redaction state assignment subsystem. Consider an example where five faces are in an image view, and 2 faces are assigned for redaction, 2 faces are assigned for non-redaction (e.g., based upon permitted imaging rights) and the last face is an unknown (someone who is not participating in the redaction world). The 2 faces to be redacted may be displayed with a red surrounding rectangle, the 2 faces that do not need redaction do to permitted imaging rights may be displayed with a green surrounding rectangle and the unknown face may be displayed with a white surrounding rectangle. When an image is actually captured and stored in memory (as opposed to just being viewed on the display), the captured image that is stored would not include the squares, but would redact the two faces that were displayed with the red rectangle graphic.

The described exemplary systems provide advantageous operating methods. For example, a first method is provided for a first mobile processing device (e.g., device 10C of FIG. 1) to identify and track a plurality of second mobile processing devices (e.g., devices 10B, 10D and 10E in FIG. 1) in a vicinity of the first mobile processing device. The first mobile processing device receives metadata transmitted from each of the second mobile processing devices via a connectionless communication scheme with each second mobile processing device, the metadata from each second mobile processing device comprising a plurality of metadata fields that include at least one device identification field, a plurality of device location fields, a plurality of device direction fields and a plurality of device orientation fields. The first mobile processing device evaluates the metadata received from each second mobile processing device to construct a topology awareness map, with each second mobile processing device being assigned to a location within the topology awareness map.

In one implementation of the first method, the first mobile processing device includes a topology build system for building the topology awareness map. For each second mobile processing device the topology build system is configured to evaluate a first layer of metadata of each second mobile processing device in order to assign both the location of the second mobile processing device within the topology map and a level of accuracy of the location. For each second mobile processing device, the topology build system is configured to evaluate whether the level of accuracy meets an acceptable threshold and: if the acceptable threshold is met, the location assigned by the topology build system remains as assigned based upon evaluation of the first layer of metadata; and if the acceptable threshold is not met, the topology build system evaluates a second layer of metadata to define an updated location and an updated level of accuracy. For each second mobile processing device for which the second layer of metadata was evaluated, the topology build system is configured to evaluate whether the updated level of accuracy meets the acceptable threshold and: if the acceptable threshold is met, the updated location assigned by the topology build system remains as assigned based upon evaluation of both the first layer of metadata and the second layer of metadata; if the acceptable threshold is not met, the topology build system evaluates a third layer of metadata to define a further updated location and a further updated level of accuracy.

In another implementation of the first method, the first mobile processing device includes a topology build system for building the topology awareness map. For each second mobile processing device the topology build system is configured to effect a layered analysis of metadata until the location of the second mobile processing device is approximated within a set level of accuracy, such that the location of each second mobile processing device is defined with a minimum amount of data processing needed to achieve the set level of accuracy.

In a further implementation of the first method, the first mobile processing device includes a topology build system for building the topology awareness map. For each second mobile processing device the topology build system is configured to sequentially evaluate multiple layers of metadata until an approximated location of the second mobile processing device is determined to be within a set level of accuracy and to subsequently forego additional layers of metadata analysis in order to reduce processing time required to achieve the set level of accuracy. The topology build system may be operable with a display (e.g. 100 in FIG. 4B) of the first mobile processing device to display a topology image that identifies the location of the first mobile processing device and the location of each of the second mobile processing devices.

A second method is provided for a first mobile processing device (e.g., device 10C in FIG. 1) to identify and track a second mobile processing device (e.g., any of devices 10B, 10D or 10E in FIG. 1) in a vicinity of the first mobile processing device. The first mobile processing device receives metadata transmitted from the second mobile processing device via a connectionless communication format, the metadata including a plurality of metadata fields. The first mobile processing device operates to determine an approximate location of the second mobile processing device relative to a location of the first mobile processing device by sequentially evaluating multiple layers of metadata until the approximate location of the second mobile processing device is determined to be within a set level of accuracy.

In one implementation of the second method, the first mobile processing device includes a topology build system (e.g., 90 in FIG. 4B) for creating a topology map in which the location of the first mobile processing device is identified and the approximate location of the second mobile processing device is identified. The topology build system is configured to define a plurality of zones relative to the location of the first mobile processing device and to assign the approximate location of the second mobile processing device to an applicable one of the zones. In the second method, one layer of metadata may be comprised of GPS metadata, a subsequent layer of metadata may comprise magnetic bearing and/or heading data and a further subsequent layer of metadata may comprise RF signal metadata. The topology build system may be operable with a display (e.g., display 100 of FIG. 4B) of the first mobile processing device to display a topology image that identifies the location of the first mobile processing device and the approximate location of the second mobile processing device.

In one example of the second method, the first mobile processing device includes an image capture device and an image redaction engine, and the topology build system operates with the image redaction engine to identify an approximate location of the second mobile processing device within a captured image in order to enable redaction of a facial image of a user of the second mobile processing device.

In one instance of the example of the second method, the metadata received by the first mobile processing device may include identification metadata associated with the user of the second mobile processing device, and the image redaction engine is configured to utilize the identification metadata to establish biometric data associated with a face of the user of the second mobile processing device, and the image redaction engine compares the biometric data with one or more facial images in the captured image in order to redact the facial image of the user of the second mobile processing device.

In another instance of the example of the second method, the image redaction engine is configured to identify any facial image in a vicinity of the approximate location. If only a single facial image is identified, the image redaction engine redacts that identified facial image without resort to biometric analysis. On the other hand, if more than one facial image is identified, the image redaction engine utilizes biometric analysis to select the appropriate facial image for redaction.

The image redaction engine may be configured to identify a facial image in a vicinity of the approximate location and assign a level of accuracy to the identified facial image, wherein the level of accuracy corresponds to a likelihood that the identified facial image is the facial image of the user of the second mobile processing device. If the level of accuracy meets a set threshold, the image redaction engine redacts the identified facial image. On the other hand, if the level of accuracy does not meet the set threshold, the image redaction engine assesses one or more additional data points to determine whether to redact the identified facial image.

A third method is provided for real-time image redaction and involves an imaging device (e.g., a camera, mobile phone or drone) wirelessly receiving image capture control metadata (e.g., the metadata packages describe above) regarding one or more other mobile wireless devices in a vicinity of the imaging device. The imaging device capturing an image of part of the vicinity and the imaging device utilizes the image capture control metadata to redact the image in real-time.

In the third method, the image capture control metadata may include facial image metadata (e.g., the biometric vector date mentioned above), and the imaging device may include an on-board facial recognition system to detect a face within the image (e.g., analyzer 96 of FIG. 4B) that corresponds to the facial image metadata and to redact the face from the image.

In the third methods, the image capture control metadata may include device identification metadata, and the imaging device may utilize the device identification data to obtain facial image metadata (e.g., from a cloud-based system). The imaging device includes an on-board facial recognition system (e.g., analyzer 96 of FIG. 4B) to detect a face within the image that corresponds to the facial image metadata and to redact the face from the image.

In the third method, the image capture control metadata typically includes location metadata of the other mobile wireless device and device identification metadata of the other mobile wireless device. The imaging device includes an image redaction system that utilizes the location metadata to identify a face (e.g., using solely location metadata or location data in combination with other metadata) within the image that corresponds to a face of a user associated with the other mobile wireless device, and the image redaction system then redacts the identified face from the image (e.g., in situations where redaction is necessary).

In some implementations of the third method, the imaging device wirelessly transmits identification information about itself and receives the image control metadata in response to the identification information. More typically, the image control metadata is received by the imaging device via a connectionless communication scheme directly from the other mobile wireless devices (e.g., without requiring the imaging device to identify itself to the other mobile wireless devices).

In instance of the third method where the imaging device includes a user display that displays an image view prior to image capture, the method may further include the imaging device detecting faces within the image view, and on the user display each face to be redacted is identified with a specific graphic and each face not to be redacted is identified by a different graphic (e.g., the different color rectangles described above).

A fourth method also provides for real-time image redaction by an imaging device and involve an imaging device (e.g., a camera, mobile phone or drone) wirelessly receiving metadata packages via a connectionless communication scheme from each of a plurality of mobile wireless devices in a vicinity of the imaging device. The imaging device processes location related metadata within the metadata packages to approximate a location of each mobile wireless device within the vicinity. The imaging device processes identification related metadata within the metadata packages and redaction setting metadata within the metadata packages to assign either a redaction required state or a redaction not required state to each mobile wireless device. The imaging device capturing an image of part of the vicinity. The imaging device determines which of the mobile wireless devices are located within the part of the vicinity and verifies a redaction state for each of the mobile wireless devices determined to be within the part of the vicinity. For each mobile wireless device that is both determined to be within the part of the vicinity and verified as having the redaction required state, the imaging device identifying within the captured image a user face associated with the mobile processing device and redacting that user face from the captured image.

In one example of the fourth method the step of identifying each user face involves sequentially evaluating multiple layers of metadata until a certainty associated with identification of the user face reaches a set threshold, such that a number of layers of metadata evaluated may vary as between different user faces.

The step of identifying each user face may occur prior to the capturing of the image when the imaging device is in an image view mode. Where the imaging device includes a user display that displays an image view in the image view mode prior to capturing of the image, the method may further includes the imaging device identifying user faces within the image view, and on the user display each user face with an assigned redaction required state is identified with a specific graphic and each user face with an assigned redaction not required state is identified by a different graphic.

The metadata packages of the fourth method may be of a predefined field format (e.g., such as the model described above).

The assignment of either the redaction required state or the redaction not required state may be carried out at least in part by accessing a contacts list to determine image related rights as between a user of the imaging device and the users of the mobile wireless devices. The contacts list may be on-board the imaging device or may be accessed over a network connection.

In any given circumstance an imaging device may utilize image capture control metadata (e.g., identity data/metadata, permissions data/metadata, location data/metadata and/or facial image data/metadata (biometrics)) to perform image redaction as required. The imaging device may receive all or some of this metadata via connectionless communication with another nearby mobile device via any number of communication schemes which may involve varying degrees or levels of data receipt and/or exchange. For example, an imaging device operating in a Receive only mode may receive identity data and facial image data transmitted by another mobile device (which may be operating in a Transmit only mode or multi-directional mode), in which case the imaging device makes its own determination of whether it has image capture rights related to the identity data and, if not, will use the facial image data to perform image redaction as necessary. In an exemplary more complex system, where the imaging device is operating in both a multi-directional mode and the other mobile device is also operating in a multi-directional mode, the imaging device may transmit its identity data, which is received by the other mobile device. The other mobile device actually makes a determination of whether the imaging device has image capture rights and, if not, transmits the necessary image capture control data (which may or may not be targeted to the specific imaging device) that is received by the imaging device and used by the image device to perform image redaction as necessary. All of these communications can be carried out in a connectionless system, and the complexity of the operations will vary depending upon the number of devices within a given local and the speeds necessary to provide users with desired performance of the systems and methods.

By way of example, the system/method provides one or more of:
A mobile device application and/or Operating System (OS) Service capable of performing imagery redaction in real-time against photos and videos being taken.
An imagery redaction metadata model that provides a metadata scheme to support the exchange of information about mobile devices and their users for the purposes of imagery redaction.
A method to discover mobile wireless devices in a peer-to-peer topology utilizing a series of connectionless communications protocols for the purposes of exchange metadata for imagery redaction.
A mobile device that is capable of performing real-time onboard imagery redaction, filtering, blurring, pixelizing, or setting pixel values of photos and videos for imagery redaction using metadata and analytics processes.
A mobile device that is capable of performing real-time onboard imagery redaction, filtering, blurring, pixelizing, or setting pixel values of faces or bodies in photos and videos for imagery redaction using metadata and analytics processes.
A mobile device application and/or Operating System (OS) Service that allows users to assign imagery rights associated to a devices established contacts list.
A mobile device application and/or Operating System (OS) Service that allows users to assign imagery rights associated to a predefined location.
A mobile device application and/or Operating System (OS) Service that allows users to assign imagery rights associated to a local contacts lists (e.g., Device Contacts), global contacts list (e.g., Social Media accounts), location(s) or other web service accounts.
A connectionless communications method to exchange imagery redaction metadata between wireless mobile devices by oversubscribing 802.11 Management frames.
A connectionless communications method to exchange imagery redaction metadata between wireless mobile devices using 802.15.4.
A connectionless communications method to exchange imagery redaction metadata between wireless mobile devices using BLE (Bluetooth Low Energy).
A connectionless communications method to exchange imagery redaction metadata between wireless mobile devices using IEEE 802.11 Wi-Fi.
A connectionless communications method to exchange imagery redaction metadata between wireless mobile devices using wireless service providers (e.g. 3G, 4G/LTE)
A connectionless communications method to exchange imagery redaction metadata between wireless mobile devices using NFC (Near Field Communications).
A connectionless communications method to exchange imagery redaction metadata between wireless mobile devices using ZigBee and/or Z-wave.
A connectionless communications method to exchange imagery redaction metadata between wireless mobile devices using iBeacons/Beacons.
A connectionless communications method to exchange imagery redaction metadata between wireless mobile devices using RFID's.
A connectionless communications method to exchange imagery redaction metadata between wireless mobile devices by oversubscribing 802.XX Management frames.
A connectionless communications method to exchange imagery redaction metadata between wireless mobile devices by utilizing Ethernet Broadcast frames.
A connectionless communications method to exchange imagery redaction metadata between wireless mobile devices by utilizing Ethernet Multicast frames.
A mobile device application and/or Operating System (OS) Service that is able to transmit imagery redaction metadata about the device and the user utilizing oversubscribed 802.11 Management frames.
A mobile device application and/or Operating System (OS) Service that is able to transmit imagery redaction metadata about the device and the user utilizing oversubscribed 802.XX Management frames.
A mobile device application and/or Operating System (OS) Service that is able to transmit imagery redaction metadata about the device and the user within Ethernet Broadcast frames.
A mobile device application and/or Operating System (OS) Service that is able to transmit imagery redaction metadata about the device and the user within Ethernet Multicast frames.
A mobile device application and/or Operating System (OS) Service that is able to receive imagery redaction metadata about a device(s) and user(s) utilizing oversubscribed 802.11 Management frames.
A mobile device application and/or Operating System (OS) Service that is able to receive imagery redaction metadata about a device(s) and user(s) utilizing oversubscribed 802.XX Management frames.
A mobile device application and/or Operating System (OS) Service that is able to receive imagery redaction metadata about a device(s) and user(s) within Ethernet Broadcast frames.
A mobile device application and/or Operating System (OS) Service that is able to receive imagery redaction metadata about a device(s) and user(s) within Ethernet Multicast frames.

It is to be clearly understood that the above description is intended by way of illustration and example only, is not intended to be taken by way of limitation, and that other changes and modifications are possible.

What is claimed is:

1. A method of real-time image redaction, comprising:
an imaging device wirelessly receiving image capture control metadata regarding one or more other mobile wireless devices in a vicinity of the imaging device;
the imaging device capturing an image of part of the vicinity;
the imaging device utilizing the image capture control metadata to redact the image in real-time.

2. The method of claim 1 wherein the image capture control metadata includes facial image metadata and the imaging device includes an on-board facial recognition system to detect a face within the image that corresponds to the facial image metadata and to redact the face from the image.

3. The method of claim 1 wherein the image capture control metadata includes device identification metadata, the imaging device utilizes the device identification data to obtain facial image metadata, and the imaging device includes an on-board facial recognition system to detect a face within the image that corresponds to the facial image metadata and to redact the face from the image.

4. The method of claim 1 wherein the image capture control metadata includes location metadata of the other mobile wireless device and device identification metadata of the other mobile wireless device.

5. The method of claim 4 wherein the imaging device includes an image redaction system that utilizes the location metadata to identify a face within the image that corresponds to a face of a user associated with the other mobile wireless device, and the image redaction system then redacts the identified face from the image.

6. The method of claim 1 wherein the imaging device wirelessly transmits identification information about itself and receives the image control metadata in response to the identification information.

7. The method of claim 1 wherein the image control metadata is received by the imaging device via a connectionless communication scheme directly from the other mobile wireless devices.

8. The method of claim 1 wherein the imaging device includes a user display that displays an image view prior to image capture, and the method further includes the imaging device detecting faces within the image view, and on the user display each face to be redacted is identified with a specific graphic and each face not to be redacted is identified by a different graphic.

9. A method of real-time image redaction by an imaging device, comprising:
an imaging device wirelessly receiving metadata packages via a connectionless communication scheme from each of a plurality of mobile wireless devices in a vicinity of the imaging device;
the imaging device processing location related metadata within the metadata packages to approximate a location of each mobile wireless device within the vicinity;
the imaging device processing identification related metadata within the metadata packages and redaction setting metadata within the metadata packages to assign either a redaction required state or a redaction not required state to each mobile wireless device;
the imaging device capturing an image of part of the vicinity;
the imaging device determining which of the mobile wireless devices are located within the part of the vicinity and verifying a redaction state for each of the mobile wireless devices determined to be within the part of the vicinity;
for each mobile wireless device that is both determined to be within the part of the vicinity and verified as having the redaction required state, the imaging device identifying within the captured image a user face associated with the mobile processing device and redacting that user face from the captured image.

10. The method of claim 9 wherein the step of identifying each user face involves sequentially evaluating multiple layers of metadata until a certainty associated with identification of the user face reaches a set threshold, such that a number of layers of metadata evaluated may vary as between different user faces.

11. The method of claim 9 wherein the step of identifying each user face occurs prior to the capturing of the image when the imaging device is in an image view mode.

12. The method of claim 11 wherein the imaging device includes a user display that displays an image view in the image view mode prior to capturing of the image, and the method further includes the imaging device identifying user faces within the image view, and on the user display each user face with an assigned redaction required state is identified with a specific graphic and each user face with an assigned redaction not required state is identified by a different graphic.

13. The method of claim 9 wherein the metadata packages are of a predefined field format.

14. The method of claim 9 wherein the assignment of either the redaction required state or the redaction not required state is carried out at least in part by accessing a contacts list to determine image related rights as between a user of the imaging device and the users of the mobile wireless devices.

15. A mobile wireless device for performing real-time onboard imagery redaction, comprising:
an image capture device for capturing an image in a vicinity of the mobile wireless device;
a metadata decode engine for decoding metadata packages received by the mobile wireless device in a connectionless communication format from third-party mobile wireless devices;
a user identification extraction engine for identifying users associated with received metadata packages;
an imaging rights assessment engine for determining whether the mobile wireless device is permitted to capture facial images of the identified users; and
an image redaction engine for identifying within captured images each user face that the mobile wireless device is not permitted to capture and for redacting each such user face from the captured image.

16. The mobile wireless device of claim 15 wherein the image redaction engine utilizes one or more of filtering, blurring, pixelizing or setting pixel values within the captured image.

17. The mobile wireless device of claim 15 wherein the imaging rights assessment engine accesses a contacts list.

18. The mobile wireless device of claim 15 wherein:
the image redaction engine includes:
a device location subsystem for processing location related metadata within the metadata packages to approximate a location of the third-party mobile wireless devices within a vicinity of the mobile wireless device;
a device filter subsystem for determining which third-party mobile wireless devices are likely within an image view of the image capture device and which third-party mobile wireless devices are likely not within the image view of the image capture device;
a redaction state assignment subsystem for identifying user faces within the image view, associating at least some of the user faces to respective third-party mobile wireless devices and establishing a redaction state for each identified user face.

19. The mobile wireless device of claim 18 wherein, when associating user faces to respective third-party mobile wireless devices, the redaction state assignment subsystem operates by focusing on third-party mobile wireless devices identified as likely within the image view.

20. The mobile wireless device of claim 19, further comprising:
a display for displaying the image view, and a display control that is configured to cause each user face within the image view to be displayed with an associated graphic that indicates whether the user face will be redacted based upon the redaction state established by the redaction state assignment subsystem.

21. A mobile device application and/or operating system (OS) service operating in connection with a mobile wireless device having a processing system, comprising:
an image capture control feature that allows a user to selectively assign image capture rights on an individual basis to specific user contacts.

22. The application or service of claim 21 wherein the user contacts are associated with a local contacts lists or global contacts list.

23. A method of a first mobile processing device identifying and tracking a plurality of second mobile processing devices in a vicinity of the first mobile processing device, the method comprising:
the first mobile processing device receiving metadata transmitted from each of the second mobile processing devices via a connectionless communication scheme with each second mobile processing device, the metadata from each second mobile processing device comprising a plurality of metadata fields that include at least one device identification field, a plurality of device location fields, a plurality of device direction fields and a plurality of device orientation fields;
the first mobile processing device evaluating the metadata received from each second mobile processing device to construct a topology awareness map, with each second mobile processing device being assigned to a location within the topology awareness map.

24. The method of claim 23 wherein the first mobile processing device includes a topology build system for building the topology awareness map, wherein for each second mobile processing device the topology build system is configured to evaluate a first layer of metadata of each second mobile processing device in order to assign both the location of the second mobile processing device within the topology map and a level of accuracy of the location.

25. The method of claim 24 wherein, for each second mobile processing device, the topology build system is configured to evaluate whether the level of accuracy meets an acceptable threshold and:
if the acceptable threshold is met, the location assigned by the topology build system remains as assigned based upon evaluation of the first layer of metadata;
if the acceptable threshold is not met, the topology build system evaluates a second layer of metadata to define an updated location and an updated level of accuracy.

26. The method of claim 25 where, for each second mobile processing device for which the second layer of metadata was evaluated, the topology build system is configured to evaluate whether the updated level of accuracy meets the acceptable threshold and:
if the acceptable threshold is met, the updated location assigned by the topology build system remains as assigned based upon evaluation of both the first layer of metadata and the second layer of metadata;
if the acceptable threshold is not met, the topology build system evaluates a third layer of metadata to define a further updated location and a further updated level of accuracy.

27. The method of claim 23 wherein the first mobile processing device includes a topology build system for building the topology awareness map, wherein for each second mobile processing device the topology build system is configured to effect a layered analysis of metadata until the location of the second mobile processing device is approximated within a set level of accuracy, such that the location of each second mobile processing device is defined with a minimum amount of data processing needed to achieve the set level of accuracy.

28. The method of claim 23 wherein the first mobile processing device includes a topology build system for building the topology awareness map, wherein for each second mobile processing device the topology build system is configured to sequentially evaluate multiple layers of metadata until an approximated location of the second mobile processing device is determined to be within a set level of accuracy and to subsequently forego additional layers of metadata analysis in order to reduce processing time required to achieve the set level of accuracy.

29. The method of claim 28 wherein the topology build system is operable with a display of the first mobile processing device to display a topology image that identifies the location of the first mobile processing device and the location of each of the second mobile processing devices.

30. A method of a first mobile processing device identifying and tracking a second mobile processing device in a vicinity of the first mobile processing device, the method comprising:
the first mobile processing device receiving metadata transmitted from the second mobile processing device via a connectionless communication format, the metadata comprising a plurality of metadata fields;
the first mobile processing device operates to determine an approximate location of the second mobile processing device relative to a location of the first mobile processing device by sequentially evaluate multiple layers of metadata until the approximate location of the second mobile processing device is determined to be within a set level of accuracy.

31. The method of claim 30 wherein the first mobile processing device includes a topology build system for creating a topology map in which the location of the first mobile processing device is identified and the approximate location of the second mobile processing device is identified, wherein the topology build system is configured to define a plurality of zones relative to the location of the first mobile processing device and to assign the approximate location of the second mobile processing device to an applicable one of the zones.

32. The method of claim 31 wherein one layer of metadata is comprised of GPS metadata, a subsequent layer of metadata comprises magnetic bearing and/or heading data and a further subsequent layer of metadata comprises RF signal metadata.

33. The method of claim 32 wherein the topology build system is operable with a display of the first mobile processing device to display a topology image that identifies the location of the first mobile processing device and the approximate location of the second mobile processing device.

34. The method of claim 30 wherein the first mobile processing device includes an image capture device and an image redaction engine, the topology build system operates with the image redaction engine to identify an approximate location of the second mobile processing device within a captured image in order to enable redaction of a facial image of a user of the second mobile processing device.

35. The method of claim 34 wherein the metadata received by the first mobile processing device includes identification metadata associated with the user of the second mobile processing device, the image redaction engine is configured to utilize the identification metadata to establish biometric data associated with a face of the user of the second mobile processing device, and the image redaction engine compares the biometric data with one or more facial images in the captured image in order to redact the facial image of the user of the second mobile processing device.

36. The method of claim 34 wherein the image redaction engine is configured to identify any facial image in a vicinity of the approximate location and:
if only a single facial image is identified, the image redaction engine redacts that identified facial image without resort to biometric analysis;
if more than one facial image is identified, the image redaction engine utilizes biometric analysis to select the appropriate facial image for redaction.

37. The method of claim 34 wherein the image redaction engine is configured to identify a facial image in a vicinity of the approximate location and assign a level of accuracy to the identified facial image, wherein the level of accuracy corresponds to a likelihood that the identified facial image is the facial image of the user of the second mobile processing device and:
if the level of accuracy meets a set threshold, the image redaction engine redacts the identified facial image;
if the level of accuracy does not meet the set threshold, the image redaction engine assesses one or more additional data points to determine whether to redact the identified facial image.

38. A wireless mobile processing device, comprising:
a metadata collection and transmit system for configuring data regarding the wireless mobile processing device so as to enable communication of the information to other wireless mobile processing devices, wherein the metadata collect and transmit system is configured to operate in accordance with a predefined metadata structure, the predefined metadata structure comprised of a plurality of predefined metadata fields that include at least one device identification field, one or more device location fields, one or more device direction fields and one or more device orientation fields, the metadata collection and transmit system configured to:
identify data consistent with the predefined metadata structure;
store identified data into appropriate fields of the predefined metadata structure;
repeat the identify and store steps in order to maintain the predefined metadata structure in an updated state;
at least one wireless communication system enabling the mobile communications device to transmit wireless signals;
wherein the metadata collection and transmit system is configured with at least one enabled mode in which the metadata collection and transmit system operates with the wireless communication system to repeatedly transmit the predefined metadata structure in a connectionless communication scheme format for reception by other mobile processing devices.

39. The mobile processing device of claim 38 wherein the metadata collection and transmit system comprises a metadata encoder connected to received data from a plurality of sources on board the mobile processing device, including at least one device identification source, at least one device location source, at least one device direction source and at least one device orientation source.

40. The mobile processing device of claim 39 wherein the metadata collection and transmit system is configured with at least one non-enabled mode in which the metadata collection and transmit system does not operate with the wireless communication system to repeatedly transmit the predefined metadata structure in a connectionless communication scheme format for reception by other mobile processing devices.

41. The mobile processing device of claim 40 wherein in the non-enabled mode the metadata collection and transmit system continues to operate to maintain the predefined metadata structure in an updated state so as to enable efficient transition from the non-enabled mode to the enabled mode.

42. The mobile processing device of claim 40 wherein the non-enabled mode is triggered through an image privacy application running on the mobile processing device.

43. The mobile processing device of claim 39 wherein the metadata collection and transmit system is configured to insert null data into each field of the predefined metadata structure as to which the metadata collection and transmit system lacks applicable data such that other mobile processing devices can recognize such fields as lacking applicable data when the predefined metadata structure is received.

44. The mobile processing device of claim 43 wherein the metadata collection and transmit system is configured to truncate each field of the predefined metadata structure as to which the metadata collection and transmit system lacks applicable data such that a size of the predefined metadata structure as transmitted in the connectionless communication scheme format is thereby reduced for efficiency purposes.

45. The mobile processing device of claim 38 wherein:
the at least one device identification field includes one or more of a UUID field, a MAC address field and an IP address field;
the plurality of device location fields include one or more of a location latitude field, a location longitude field and a location altitude field;
the plurality of device direction fields include one or more of a course field, a bearing field and at least one heading field; and
the plurality of device orientation fields include one or more of a pitch field, a roll field and a yaw field.

46. The mobile processing device of claim 38 wherein the predefined metadata structure includes at least one field with biometric facial data associated with a known user of the mobile processing device to enable other mobile processing devices with image capture functions that receive the predefined metadata structure to identify the user within a captured image.
